(19) United States
(12) Patent Application Publication
(10) Pub. No.: US 2024/0315183 A1
(43) Pub. Date: Sep. 26, 2024

(54) Vertical Hydroponic System

(71) Applicant: Happy Planet Holdings, LLC, Redding, CA (US)

(72) Inventors: Arthur Moore, Redding, CA (US); Cheryl Moore, Redding, CA (US)

(73) Assignee: Happy Planet Holdings, LLC, Redding, CA (US)

(21) Appl. No.: 18/189,702

(22) Filed: Mar. 24, 2023

(51) Int. Cl. A01G 31/02; A01G 7/04; A01G 29/00

(52) U.S. Cl. CPC A01G 31/02; A01G 7/045; A01G 29/00; A01G 2031/006

(57) ABSTRACT

A closed hydroponic vertical modular cultivation system, comprising: a lighting system; a system pump; a nutrient supply reservoir; a reservoir cover; a nutrient supply pipe; a hydroponic vertical modular cultivation system panel; and a nutrient return pipe. The closed system pumps a nutrient aqueous solution to seedlings that are in stabilization collars that are integrated into the troughs of the panel. The system, panel, and lighting system are vertically orientated and several lighting systems and panels may be part of one system.

### FIELD OF USE

The present disclosure relates, in general, to a hydroponic growing system and method. More specifically, the present disclosure relates to a wholly enclosed vertical hydroponic growing system. A vertical hydroponic growing system allows for more efficient use of the nutrient aqueous solution and improved seedling's root system respiration.

### BACKGROUND

For many years growers have used hydroponic systems to grow vegetation in urban, arid, and space-constrained areas. Hydroponics is a type of horticulture and a subset of hydroculture that involves growing plants, usually crops or medicinal plants, without soil, using water-based mineral nutrient solutions in aqueous solvents.

Various types of conventional hydroponic systems differ in the plant support geometry and method of delivery of the water-based mineral nutrient solution. Among these various types is a horizontal system that submerses the plant's roots in a nutrient aqueous solution and light from above. In addition, various kinds of soilless grow media are used to support the plants and their root systems. For example, porous materials are used as growing media in hydroponics, including organic media like coconut coir, peat, and pine bark and inorganic mediums such as mineral wool, grow stone, perlite, and sand.

Hydroponic systems have traditionally provided a solution to a geographically limited climate and limited growing season with the benefit of improved growth yield, increased production per space, efficient use of water, and lower pest control problems.

However, even though hydroponic systems can be employed in almost any space, the horizontal orientation and light, usually from above, have led to inefficient use of available space and limited area for light sources.

To provide a better solution to the traditional inefficiencies, what is needed is a solution that is better able to take advantage of the entire space three-dimensionally.

### SUMMARY

To minimize the limitations in the prior art, and to minimize other limitations that will become apparent upon reading and understanding the present specification, the present disclosure discloses a new and useful vertical hydroponic device, system, and method.

The following presents a simplified overview of the example embodiments in order to provide a basic understanding of some embodiments of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented herein below. It is to be understood that both the following general description and the following detailed description are exemplary and explanatory only and are not restrictive.

To more efficiently utilize the available space three dimensionally a hydroponic system oriented vertically allows for placement of lighting systems in the same plane as the hydroponic system. This addresses the inefficient use of the light sources and allows for a more efficient use of the available space. The system is preferably wholly and/or entirely closed, which may reduce or even prevent algae growth by preventing light sources from contacting the aqueous nutrient supply enclosed within the system. The vertical orientation also allows for complete drainage of the hydroponic system and continuous recycling of unused nutrient solution.

The present disclosure discloses a better and more efficient system and method of utilizing the available growing space. As disclosed in the present disclosure, a hydroponic system may be oriented vertically where the vertical orientation may allow for an adjustable placement of lighting systems in the same plane as the hydroponic system. This addresses the inefficient use of the light sources and allows for a more efficient use of the available space. The vertical orientation also allows for complete drainage of the hydroponic system and continuous recycling of unused nutrient solution. The present disclosure further discloses a method of maintaining a plant and or seedling in a horizontal orientation which allows for unobstructed growth and respiration of the plant root system.

One embodiment may be a closed hydroponic vertical modular cultivation system that may comprise: a lighting system, a system pump, a nutrient supply reservoir, a reservoir cover, a nutrient supply pipe, a hydroponic vertical modular cultivation system panel, a nutrient return pipe, a nutrient aqueous solution, and a seedling; wherein the lighting system is vertically orientated to the hydroponic vertical modular cultivation system panel; wherein the system pump is in fluid communication with the supply nutrient supply reservoir; wherein the system pump is in fluid communication with the nutrient supply pipe; wherein the nutrient supply pipe is in fluid communication with the hydroponic vertical modular cultivation system panel; wherein the hydroponic vertical modular cultivation system panel is in fluid communication with the nutrient return pipe, wherein the nutrient aqueous solution is pumped through a closed hydroponic vertical modular cultivation system; wherein the seedlings absorb the aqueous solution; and wherein a reservoir cover encloses the nutrient supply reservoir. The lighting system may comprise an array of light emitting diodes (LEDs). The lighting system may be configured to be a variable distance away from the hydroponic vertical modular cultivation system panel. The system pump may be submersible. The nutrient supply reservoir may be configured to collect the nutrient aqueous solution that has escaped. Plant growth promoting lights are well known in the art and may include LEDs (both violet-blue and red spectrum), fluorescent lights/bulbs, including compact, high-pressure sodium (HPS), which are sometimes referred to as high intensity discharge lights (HID), and incandescent bulbs.

Another embodiment may be a hydroponic vertical modular cultivation system panel comprising: a manifold housing, a plurality of hydroponic troughs, an internal plant root environment, a plurality of seedling roots, a plurality of stabilization collar, a plurality of seedlings, a plurality of ceiling hangers, a plurality of pipe hangers, a plurality of root access portals, a drain return pipe, where the manifold housing may be connected to the nutrient supply pipe allowing for fluid flow, and the manifold housing may house the nutrient distribution manifold; wherein the manifold housing may seal with the plurality of hydroponic troughs, wherein the hydroponic troughs have a plurality of root access portals; wherein the root access portals are sealed with the stabilization collars; wherein the stabilization collars retain the seedlings; wherein the internal root environment may be independently controlled; wherein the hydroponic troughs seal with drain return pipes; wherein the hydroponic vertical modular cultivation system panel may be vertically maintained by the set of ceiling hangers; and wherein the hydroponic vertical modular cultivation system panel may be vertically maintained by the plurality of pipe hangers. The system pump may be submersible. The nutrient distribution manifold may comprise: a PVC interconnect, a nutrient manifold delivery port, and an end plug, wherein the nutrient distribution manifold may be connected to the nutrient supply pipe; wherein the PVC interconnects may attach to the nutrient manifold delivery ports, wherein the nutrient distribution manifold may be connected to a plurality of nutrient manifold delivery ports; wherein the nutrient distribution manifold may be sealed with the end plug; and wherein the manifold may be connected to the hydroponic troughs. The stabilization collar may seal the root access portal. The stabilization collar may be circular, disc shaped, and/or cylindrical.

Another embodiment may be a closed hydroponic vertical modular cultivation system, comprising: a lighting system, a system pump, a nutrient supply reservoir, a reservoir cover, a nutrient supply pipe, a hydroponic vertical modular cultivation system panel, a nutrient return pipe, a nutrient aqueous solution, and a seedling; wherein the lighting system may be vertically orientated to the hydroponic vertical modular cultivation system panel; wherein the system pump may be connected to the supply nutrient supply reservoir allowing for fluid to flow; wherein the system pump may be connected to the nutrient supply pipe; wherein the nutrient supply pipe may be connected to the hydroponic vertical modular cultivation system panel; wherein the hydroponic vertical modular cultivation system panel may be connected to the nutrient return pipe allowing for fluid to flow, wherein the nutrient aqueous solution may be pumped through the closed hydroponic vertical modular cultivation system; wherein the seedlings absorb the aqueous solution; and wherein the reservoir cover may enclose the nutrient supply reservoir. The nutrient supply reservoir may collect the nutrient aqueous solution that has escaped. The hydroponic vertical modular cultivation system panel may comprise: a manifold housing a plurality of hydroponic troughs, an internal plant root environment, a plurality of seedling roots, a plurality of stabilization collar, a plurality of seedlings, a plurality of ceiling hangers, a plurality of pipe hangers, a plurality of root access portals, and a drain return pipe; wherein the manifold housing may be connected to the nutrient supply pipe; wherein the manifold housing may be connected to the nutrient distribution manifold; wherein the manifold housing may seal the plurality of hydroponic troughs; wherein the plurality of hydroponic troughs may have a plurality of root access portals; wherein the root access portals may seal with the stabilization collars; wherein the stabilization collars may retain the seedlings; wherein the internal root environment may be independently controlled; wherein the plurality of hydroponic troughs may seal the drain return pipes; wherein the hydroponic vertical modular cultivation system panel may be vertically maintained by the plurality of ceiling hangers; and wherein the hydroponic vertical modular cultivation system panel may be vertically maintained by the plurality of pipe hangers. The nutrient distribution manifold may comprise: a PVC interconnect, a nutrient manifold delivery port, and an end plug; wherein the nutrient distribution manifold may be connected to the nutrient supply pipe allowing for fluid flow; wherein the PVC interconnects may attach the nutrient manifold delivery ports; wherein the nutrient distribution manifold may be connected to a plurality of nutrient manifold delivery ports; wherein the nutrient distribution manifold may seal the end plug; and wherein the manifold may be connected to the hydroponic troughs. The lighting system may be natural light source. The system pump may be inline. The stabilization collars may be square.

Another embodiment may be a method of cultivating plants comprising the steps:
supplying a nutrient aqueous solution from a nutrient supply reservoir;
pumping the nutrient aqueous solution through a nutrient supply pipe;
providing the pumped nutrient aqueous solution from a nutrient supply pipe into a hydroponic vertical modular cultivation system panel;
distributing the nutrient aqueous solution using a nutrient distribution manifold;
draining the nutrient aqueous solution from the nutrient distribution manifold over the roots of a seedling in an enclosed trough of the hydroponic vertical modular cultivation panel; and
returning the nutrient aqueous solution that was not absorbed by roots of a seedling to a reservoir (typically the nutrient supply reservoir);
wherein the roots of a seedling are allowed to grow freely into the hollow root environment of the enclosed trough; and
wherein the hollow root environment allows a seedling unobstructed root respiration.

Another embodiment may be: a closed hydroponic vertical modular cultivation system, comprising: one or more light sources; at least one system pump; at least one nutrient supply reservoir; at least one nutrient supply pipe; one or more hydroponic vertical modular cultivation system panels; and at least one nutrient return pipe. Each of the one or more light sources may be vertically orientated and positioned approximately in front of at least one of the one or more hydroponic vertical modular cultivation system panels. The system pump may be configured to pump a nutrient aqueous solution contained within the at least one nutrient supply reservoir into the at least one nutrient supply pipe. The nutrient supply pipe may be configured to deliver the nutrient aqueous solution to the one or more hydroponic vertical modular cultivation system panels. Each of the hydroponic vertical modular cultivation system panels may comprise: a nutrient distribution manifold; one or more vertical troughs, which are substantially hollow; one or more stabilization collars; and a drain return pipe; wherein the nutrient distribution manifold comprises: a manifold housing, which comprises one or more trough openings; a nutrient supply pipe manifold portion, which comprises one or more openings; wherein the one or more trough openings may be configured to connect with the one or more vertical troughs; wherein at least one of the one or more vertical troughs has one or more root access ports; wherein the one or more root access ports may be configured connect with the one or more stabilization collars; wherein the one or more stabilization collars may be configured to hold a seedling, such that a plurality of roots of the seedling may be on an interior of the at least one of the one or more vertical troughs; wherein the one or more stabilization collars may be configured to be substantially free from leaking the nutrient aqueous solution; wherein the at least one nutrient return pipe may be configured to connect with the drain return pipe; wherein the nutrient aqueous solution may be cyclically pumped through the closed hydroponic vertical modular cultivation system; and wherein the plurality of roots of the seedling absorbs the nutrient aqueous solution as the nutrient aqueous solution may be cyclically pumped through the closed hydroponic vertical modular cultivation system. The closed hydroponic vertical modular cultivation system may further comprise a reservoir cover that may substantially cover a top of the nutrient supply reservoir. The trough openings may be configured to matingly seal with the one or more vertical troughs. The openings of the nutrient supply pipe manifold portion may be configured to be approximately located at the one or more trough openings. The system pump may be configured to variably control a flow rate of the nutrient aqueous solution through the closed hydroponic vertical modular cultivation system. The nutrient distribution manifold may comprise: one or more end plugs; and one or more adapters; wherein the one or more end plugs substantially prevent the nutrient aqueous solution from leaving the nutrient distribution manifold except as through the one or more trough openings; wherein the one or more adapters may be configured to allow the at least one nutrient supply pipe to pass into an interior of the nutrient distribution manifold. The light sources may comprise an array of light emitting diodes. The light sources may be configured to be an adjustable distance away from the one or more hydroponic vertical modular cultivation system panels. The system pump may be configured to be submersible in the nutrient aqueous solution in the nutrient supply reservoir. The closed hydroponic vertical modular cultivation system may further comprise: at least one catch reservoir; wherein the at least one catch reservoir may be configured to be placed underneath the one or more hydroponic vertical modular cultivation system panels and collect the nutrient aqueous solution that has escaped the closed hydroponic vertical modular cultivation system. The hydroponic vertical modular cultivation system panel may further comprise: one or more ceiling hangers; and one or more pipe hangers; wherein the one or more ceiling hangers and the one or more pipe hangers may be configured to connect the one or more hydroponic vertical modular cultivation system panels to a ceiling, such that the one or more hydroponic vertical modular cultivation system panels hang from the ceiling in a substantially vertical manner. The stabilization collars may be neoprene.

Another embodiment may be a closed hydroponic vertical modular cultivation system, comprising: a light source; a system pump; a nutrient supply reservoir; a nutrient supply pipe; a hydroponic vertical modular cultivation system panel; and a nutrient return pipe; wherein the system pump may be configured to pump a nutrient aqueous solution contained within the nutrient supply reservoir into the nutrient supply pipe; wherein the nutrient supply pipe may be configured to deliver the nutrient aqueous solution to the hydroponic vertical modular cultivation system panel; wherein the hydroponic vertical modular cultivation system panel comprises: one or more vertical troughs, which may be substantially hollow; one or more stabilization collars; wherein at least one of the one or more vertical troughs has one or more root access ports; wherein the one or more root access ports may be configured matingly seal with the one or more stabilization collars; wherein each of the one or more stabilization collars may be configured to hold a seedling, such that a plurality of roots of the seedling may be on an interior of the at least one of the one or more vertical troughs; wherein the nutrient aqueous solution may be cyclically pumped through the closed hydroponic vertical modular cultivation system; and wherein the plurality of roots of the seedling absorbs the nutrient aqueous solution as the nutrient aqueous solution may be cyclically pumped through the closed hydroponic vertical modular cultivation system. The hydroponic vertical modular cultivation system panel may further comprise: a nutrient distribution manifold; and a drain return pipe; wherein the nutrient distribution manifold comprises: a manifold housing, which comprises one or more trough openings; and a nutrient supply pipe manifold portion, which comprises one or more openings; wherein the one or more trough openings may be configured to connect with the one or more vertical troughs; wherein the one or more stabilization collars may be configured to be substantially free from leaking the nutrient aqueous solution; and wherein the nutrient return pipe may be configured to connect with the drain return pipe. The light source may be vertically orientated and adjustably positioned in front of the hydroponic vertical modular cultivation system panel. The closed hydroponic vertical modular cultivation system may further comprise: a reservoir cover; wherein the reservoir cover substantially covers a top of the nutrient supply reservoir; and wherein the system pump may be configured to variably control a flow rate of the nutrient aqueous solution through the closed hydroponic vertical modular cultivation system. The openings of the nutrient supply pipe manifold portion may be configured to be approximately located at the one or more trough openings. The distribution manifold further comprises: one or more end plugs; and one or more adapters; wherein the one or more end plugs substantially prevent the nutrient aqueous solution from leaving the nutrient distribution manifold except as through the one or more trough openings; wherein the one or more adapters may be configured to allow the at least one nutrient supply pipe to pass into an interior of the nutrient distribution manifold. The closed hydroponic vertical modular cultivation system may further comprise: a catch reservoir; one or more ceiling hangers; and one or more pipe hangers; wherein the catch reservoir may be configured to be placed underneath the hydroponic vertical modular cultivation system panel and to collect any of the nutrient aqueous solution that inadvertently escapes the hydroponic vertical modular cultivation system panel; and wherein the one or more ceiling hangers and the one or more pipe hangers may be configured to connect the one or more hydroponic vertical modular cultivation system panels to a ceiling, such that the one or more hydroponic vertical modular cultivation system panels hang from the ceiling in a substantially vertical manner.

Another embodiment may be a closed hydroponic vertical modular cultivation system, comprising: a light source; a system pump; a nutrient supply reservoir; a nutrient supply pipe; a hydroponic vertical modular cultivation system panel; a reservoir cover; a catch reservoir; one or more ceiling hangers; one or more pipe hangers; and a nutrient return pipe; wherein the reservoir cover substantially covers a top of the nutrient supply reservoir; wherein the light source may be vertically orientated and adjustably positioned in front of the hydroponic vertical modular cultivation system panel; wherein the system pump may be configured to pump a nutrient aqueous solution contained within the nutrient supply reservoir into the nutrient supply pipe; wherein the system pump may be configured to variably control a flow rate of the nutrient aqueous solution through the closed hydroponic vertical modular cultivation system; wherein the nutrient supply pipe may be configured to deliver the nutrient aqueous solution to the hydroponic vertical modular cultivation system panel; wherein the hydroponic vertical modular cultivation system panel comprises: one or more vertical troughs, which may be substantially hollow; one or more stabilization collars; wherein at least one of the one or more vertical troughs has one or more root access ports; wherein the one or more root access ports may be configured matingly seal with the one or more stabilization collars; wherein each of the one or more stabilization collars may be configured to hold a seedling, such that a plurality of roots of the seedling may be on an interior of the at least one of the one or more vertical troughs; wherein the nutrient aqueous solution may be cyclically pumped through the closed hydroponic vertical modular cultivation system; wherein the plurality of roots of the seedling absorbs the nutrient aqueous solution as the nutrient aqueous solution may be cyclically pumped through the closed hydroponic vertical modular cultivation system; wherein the catch reservoir may be configured to be placed underneath the hydroponic vertical modular cultivation system panel and to collect any of the nutrient aqueous solution that inadvertently escapes the hydroponic vertical modular cultivation system panel; and wherein the one or more ceiling hangers and the one or more pipe hangers may be configured to connect the one or more hydroponic vertical modular cultivation system panels to a ceiling, such that the one or more hydroponic vertical modular cultivation system panels hang from the ceiling in a substantially vertical manner. The hydroponic vertical modular cultivation system panel may further comprise: a nutrient distribution manifold; and a drain return pipe; wherein the nutrient distribution manifold comprises: a manifold housing, which comprises one or more trough openings; and a nutrient supply pipe manifold portion, which comprises one or more openings; one or more end plugs; and one or more adapters; wherein the one or more end plugs substantially prevent the nutrient aqueous solution from leaving the nutrient distribution manifold except as through the one or more trough openings; wherein the one or more adapters may be configured to allow the at least one nutrient supply pipe to pass into an interior of the nutrient distribution manifold; wherein the one or more trough openings may be configured to connect with the one or more vertical troughs; wherein the one or more stabilization collars may be configured to be substantially free from leaking the nutrient aqueous solution; wherein the one or more openings of the nutrient supply pipe manifold portion may be configured to be approximately located at the one or more trough openings; and wherein the nutrient return pipe may be configured to connect with the drain return pipe.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is an illustration of a one embodiment of a closed hydroponic vertical modular cultivation system.

FIG. 2 is an illustration of a side view of one embodiment of a closed hydroponic vertical modular cultivation system.

FIG. 3 is an illustration of one embodiment of the nutrient distribution manifold.

FIG. 4 is an illustration of a horizontal cross-section view of the trough with a stabilization collar.

FIG. 5 is an illustration of a vertical cross-section view of the trough with a stabilization collar.

FIG. 6 is an illustration of a front view of one embodiment of a cylindrical stabilization collar.

FIG. 7 is an illustration of a front view of one embodiment of a square stabilization collar.

FIG. 8 is an illustration of one embodiment of covered nutrient supply reservoir.

FIG. 9 is an illustration of a perspective view of one embodiment of a closed hydroponic vertical modular cultivation system.

FIG. 10 a flow block diagram of a method of vertically cultivating seedlings a closed hydroponic vertical modular cultivation system.

### DETAILED DESCRIPTION OF THE ILLUSTRATIVE EMBODIMENTS

In the following detailed description of various embodiments of the invention, numerous specific details are set forth in order to provide a thorough understanding of various aspects of one or more embodiments of the invention. However, one or more embodiments of the invention may be practiced without some or all of these specific details. In other instances, well-known methods, procedures, and/or components have not been described in detail so as not to unnecessarily obscure aspects of embodiments of the invention.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the screen shot figures, and the detailed descriptions thereof, are to be regarded as illustrative in nature and not restrictive. Also, the reference or non-reference to a particular embodiment of the invention shall not be interpreted to limit the scope of the invention.

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers, or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

The present methods and systems may be understood more readily by reference to the following detailed description of preferred embodiments and the examples included therein and to the Figures and their previous and following description.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about”, may refer to a deviance of between 0.001-40% from the indicated number or range of numbers.

Various embodiments are now described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments.

As used herein the term “cultivation system” refers to any system or device for growing something or improving its growth, to include the act of caring for or raising plants.

As used herein the term “lighting system” refers to any artificial light source or natural light source system, which may be designed to replicate plant growth and development. Lighting systems are normally designed to produce a light which may be suited to the process of photosynthesis.

As used herein the term “system pump” refers to any device or method capable of delivering the required amount of pressure to supply the nutrient aqueous solution to help grow the seedlings.

As used herein the term “manifold” refers to any device, system, or method of distribution of a fluid or gas that serves to bring many valves or openings into one place or a single channel into an area where many points meet.

As used herein the term “pipe” refers to any tube of PVC, metal, plastic, or other material used to convey nutrient aqueous solution, water, gas, oil, or other fluid/liquid substances.

As used herein the term “reservoir” refers to any natural or artificial body or container used as a source or collection of water, liquid solution, or fluid supply.

As used herein the term “nutrient aqueous solution” refers to any nutrient aqueous solution that may be a carefully proportioned liquid fertilizer used in hydroponic gardening.

As used herein the term “root access portal” refers to any small, usually round, window or hole in the side of a pipe that may be used to access the internal plant root environment.

As used herein the term “internal plant root environment” refers to the rhizosphere—zone of chemical, biological, and physical influence generated by root growth and activity.

As used herein, the term “seedling” refers to any very young plant that may be both sexually and asexually produced, including but not limited to scions, clones, clippings, and cuttings. Although the term seedling specifically covers cuttings, a cutting is generally a portion or piece of a plant that is used in horticulture for vegetative (asexual) propagation.

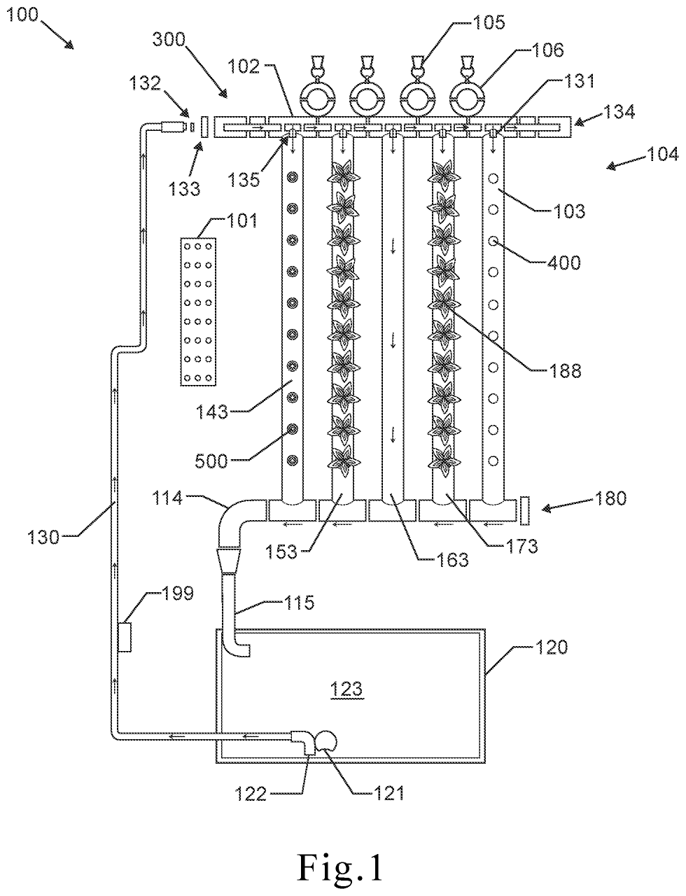

FIG. 1 is an illustration of a one embodiment of a closed hydroponic vertical modular cultivation system. In one embodiment, the hydroponic vertical modular cultivation system 100 may comprise: at least one hydroponic vertical modular cultivation system panel 104, at least one lighting system 101, at least one system pump 121, nutrient supply pipe 130, ceiling hangers 105, pipe hangers 106, at least one nutrient supply reservoir 120, nutrient aqueous solution 123, and a nutrient return pipe 115. The hydroponic vertical modular cultivation system panel 104 may be a sealed assembly of variable sizes and there may be several hydroponic vertical modular cultivation system panels 104 in the hydroponic vertical modular cultivation system 100. In one embodiment, lighting system 101 can be a single light source or may comprise a plurality of lights.

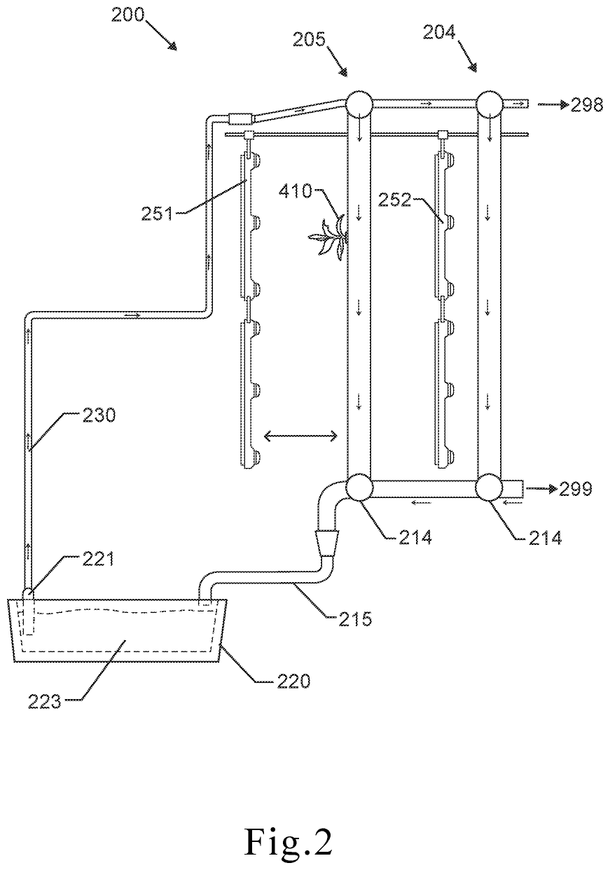

In one embodiment, nutrient supply reservoir 120 may be made from polyvinyl chloride (“PVC”). As shown in FIG. 1, the supply reservoir 120 can be at a lower elevation than the hydroponic vertical modular cultivation system panel 104. Although only a single nutrient supply reservoir 120 is shown, the hydroponic vertical modular cultivation system 100 may comprise multiple reservoirs, including one or two reservoirs per hydroponic vertical modular cultivation system panel 104. In other embodiments, each reservoir may feed multiple panels, as shown in FIG. 2. Preferably, each nutrient supply reservoir 120 has at least one nutrient supply pipe 130 and a nutrient return pipe 115. The nutrient supply reservoir 120 may also house the system pump 121, which may be submerged in the nutrient aqueous solution 123 that is contained in the nutrient supply reservoir 120. The system pump 121 may be configured to be turned on and off, allowing for intermittent flow control. The intermittent flow control of the system pump 121 may reduce added heat to the nutrient aqueous solution 123. Reducing added heat from the system pump 121 may also assist in reducing unwanted algae growth. The system pump 121 may be configured to pump the nutrient aqueous solution 123 up though intake opening 122 and into nutrient supply pipe 130. In some embodiments, the pump may be remotely controlled, manually controlled, on an automatic on-off cycle, controlled via analog timers and/or may be controlled via a digital timer or digital scheduling program.

In one embodiment, a nutrient supply pipe 130 may be configured to be physically connected to system pump 121. The system pump 121 provides the pressure and flow required to deliver the nutrient aqueous solution 123 from the nutrient reservoir 120, through the nutrient supply pipe 130, to the nutrient distribution manifold 300, where it may be allowed to fall through the hydroponic troughs 103, 143, 153, 163, 173 to the drain return pipe 114 and, finally, returned to the nutrient supply reservoir 120. The system pump 121 must overcome the head pressure associated with the vertical height of the nutrient distribution manifold 300. The nutrient supply pipe 130 may have flow value regulators and/or check valves 199, to prevent the back flow of the nutrient aqueous solution 123 out through intake opening 122. The system pump 121 is preferably configured to supply a sufficient flow to support multiple hydroponic vertical modular cultivation system panels. The system pump 121 may be submerged in the nutrient reservoir 120, or in line with the nutrient supply pipe 130. The system pump 121 may be any type of fluid or liquid pump, including, but not limited to, positive-displacement, centrifugal, and/or axial-flow pumps. There may be one or more pumps per reservoir. The system pump 121, if submerged in the nutrient supply reservoir 120, may require the nutrient supply pipe 130 to also be submerged within nutrient aqueous solution 123 of the nutrient supply reservoir 120. The nutrient supply pipe 130 preferably may connect to each hydroponic vertical modular cultivation system panel 104 at the manifold housing 102.

As shown in FIG. 1, the nutrient supply pipe 130, may be connected to a single hydroponic vertical modular cultivation system panel 104. Typically, the only limitation on the number of hydroponic modular cultivation system panels that may be connected to a single nutrient supply pipe 130 may be the size of the room where the closed hydroponic vertical modular cultivation system 100 is located and the ability of system pump 121 to source the volume of nutrient aqueous solution 123 to each hydroponic vertical modular cultivation system panel 104. The nutrient supply pipe 130 provides the nutrient aqueous solution 123 to the nutrient distribution manifold 300. The nutrient distribution manifold 300 may comprise manifold housing 102, nutrient supply pipe manifold portion 131 of nutrient supply pipe 130, end plugs 133, 134, adapter 132, and supply pipe trough openings 135. The adapter 132 is configured to allow nutrient supply pipe 130 to pass through end plug 133, such that the nutrient supply pipe manifold portion 131 of nutrient supply pipe 130 is substantially enclosed within manifold housing 102. The manifold housing may be attached to pipe hangers 106, which in turn may be attached to ceiling hangers 105, such that the manifold housing 102 may hang from or otherwise be attached to the ceiling.

In one embodiment, a hydroponic vertical modular cultivation system panel 104 may comprise a nutrient distribution manifold 300, at least one, but preferably a plurality of, hydroponic troughs 103, 143, 153, 163, 173, at least one, but preferably a plurality of, stabilization collars 500, drain return pipe 114, and drain return pipe end plug 180. The maximum number of the vertical hydroponic trough(s) 103, 143, 153, 163, 173 in any one hydroponic vertical modular cultivation system panel 104 may be associated with or determined by the capabilities of the system pump 121 and the ability of system pump 121 to supply the nutrient aqueous solution 123 at an appropriate flow rate. The size of the space containing the hydroponic vertical modular cultivation system 100 may also determine the maximum size of the hydroponic vertical modular cultivation system panel 104. The size and shape of the part of the hydroponic vertical modular cultivation system panel 104 are not limited to what is shown in FIG. 1. Each manifold housing 102, hydroponic trough 103, 143, 153, 163, 173, and drain return pipe 114 may preferably be made from four-inch PVC drainage pipe. The benefits of using PVC as a material for the hydroponic vertical modular cultivation system 100 is that PVC may be lighter and easier to work with than other hydroponic system materials such as metal, wood, or composite materials. Additionally, PVC is also not toxic. In addition, hydroponic gardening systems that use PVC pipes perform very well outdoors regardless of what the weather conditions are. Each hydroponic trough 103, 143, 153, 163, 173 may be connected to the manifold housing 102 and drain return pipe 114 using standard PVC connections, adapters, and adhesives.

As shown in FIG. 1, the hydroponic trough 103, 143, 153, 163, 173 may preferably have a plurality of root access ports 400, which provide a placement for the plant root environment 402 and stabilization collars 500. The hydroponic trough 103, 143, 153, 163, 173 may be a hollow to allow for unfettered root growth of the seedling 188 and to allow the nutrient aqueous solution 123 to flow down the hydroponic trough 103, 143, 153, 163, 173.

The hydroponic troughs 103, 143, 153, 163, 173 may comprise at least one, preferably a plurality of root access port 400. Each root access port 400 in the hydroponic troughs 103, 143, 153, 163, 173 may be cut or drilled out of the hydroponic trough 103, 143, 153, 163, 173. Each root access port 400 may be configured to matingly engage with a stabilization collar 500.

The root access ports 400 may be a size that allows for removing the seedling 188 without damaging the roots of the seedling 188. Preferably, the stabilization collars 500 form a watertight seal with the hydroponic troughs 103, 143, 153, 163, 173 at the root access ports 400. This seal allows the hydroponic vertical modular cultivation system 100 to be substantially closed and substantially eliminates loss of nutrient aqueous solution 123 as it travels the loop of the hydroponic vertical modular cultivation system 100.

In one embodiment, a nutrient return pipe 115 may connect the drain return pipe 114 of hydroponic vertical modular cultivation system panel 104 (and any other additional panels) to the nutrient supply reservoir 120. The nutrient return pipe 115 may connect multiple nutrient supply reservoirs 120. The nutrient return pipe 115 may allow unused nutrient aqueous solution 123 to be reused in the hydroponic vertical modular cultivation system 100.

FIG. 2 is an illustration of a side view of one embodiment of a closed hydroponic vertical modular cultivation system. In one embodiment, the hydroponic vertical modular cultivation system 200 may comprise: at least two hydroponic vertical modular cultivation system panels 204, 205, at least two lighting systems 251, 252 (one per panel, as preferred), at least one system pump 221, nutrient supply pipe 230, nutrient supply reservoir 220, nutrient aqueous solution 223, drain return pipe 214 and a nutrient return pipe 215. As shown, the lighting systems 251, 252 may be placed directly in front of the seedlings 410 and may be of an adjustable distance from the seedlings 410. The lighting system 251, 252 may also be mounted using ceiling hangers 905 and that may allow the lighting system 251, 252 to me moved away from the hydroponic vertical modular cultivation system panels 204, 205 that may allow for maintenance. As shown, lighting system 251 is further away from hydroponic vertical modular cultivation system panels 205 as compared to lighting system 252 and hydroponic vertical modular cultivation system panels 204.

In one embodiment, two individual four foot by four foot 6-bar LED lighting fixtures, systems, or sources may be used with each vertical hydroponic modular cultivation system panel, which in some embodiments may be four feet wide by eight feet long.

In some embodiments, the light sources and systems may be attached to each other and may be on rolling trollies with ceiling tracks to enable the lights to move or slide from left to right, from the front of the hydroponic modular cultivation system panel. This allows the lights to be moved out of the way for plant maintenance to be performed.

As shown in FIG. 2, nutrient supply feed receptacle 298 and drain return receptacle 299, allow for additional hydroponic vertical modular cultivation system panels to be connected to the hydroponic vertical modular cultivation system 200. The nutrient supply pipe 230 may receive the nutrient aqueous solution 223 from the system pump 221 and may deliver it through the nutrient supply pipe 230 to the top of the hydroponic vertical modular cultivation system panels 204, 205. The nutrient aqueous solution 223 may then flow down from the top of the vertical modular cultivation system hydroponic vertical modular cultivation system panels 204, 205 via gravity to the drain return pipe 214, then to the nutrient return pipe 215, and finally the nutrient supply reservoir 220.

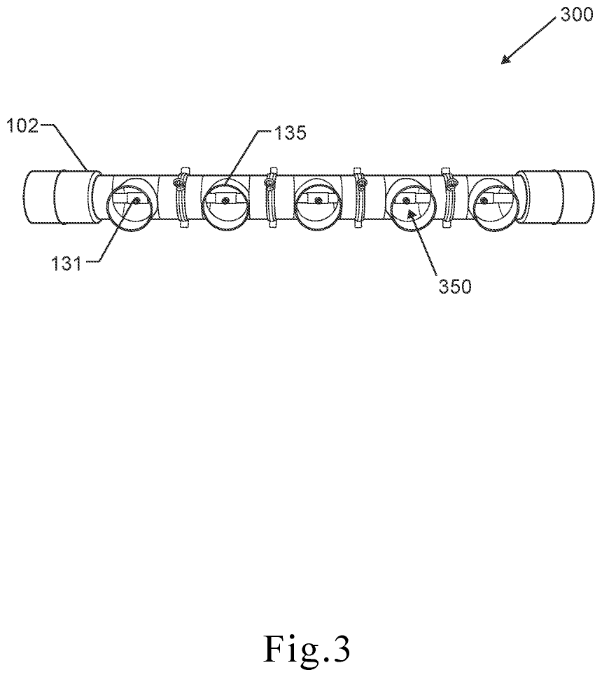

FIG. 3 is an illustration of one embodiment of the nutrient distribution manifold. FIG. 3 shows that the nutrient distribution manifold 300 may comprise manifold housing 102, nutrient supply pipe manifold portion 131 of the nutrient supply pipe, and trough openings 135. The nutrient supply pipe manifold portion 131 of the nutrient supply pipe may have nutrient supply pipe openings 350 approximately located at the trough openings 135. The nutrient aqueous solution may exit the nutrient supply pipe manifold portion 131 of the nutrient supply pipe at the nutrient supply pipe openings 350, but the nutrient aqueous solution is still contained within the closed system, which in FIG. 3 is the manifold housing 102. Typically, the plugs at the ends of the manifold housing 102 may have adapters that allows the nutrient supply pipe manifold portion 131 to be held substantially in the middle of the manifold housing 102. Other fasteners or props may be used to hold the nutrient supply pipe manifold portion 131 substantially in the middle of the manifold housing 102. Although five pipe trough openings 135 and five nutrient supply pipe openings 350 are shown, the nutrient distribution manifold may have a few as one and more than five of trough openings 135 and nutrient supply pipe openings 350.

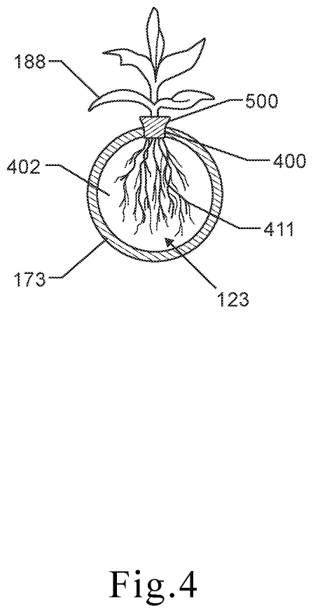

FIG. 4 is an illustration of a horizontal cross-section view of the trough with a stabilization collar. FIG. 4 shows the hydroponic trough 173 that is part of hydroponic vertical modular cultivation system panel 104 shown in FIG. 1. The nutrient aqueous solution 123 preferably fills the interior of the hydroponic trough 173 as it gradually flows in a cycle through the system. FIG. 4 shows that a stabilization collar 500 is matingly engaged with root access port 400, which may preferably be one of many holes in the sides of the hydroponic trough 173. Seedling 188 has been placed within stabilization collar 500. The leaves of seedling 188 are on the outside of hydroponic trough 173 and the seedling roots 411 are in the interior where seedling roots 411 may be contacted by the nutrient aqueous solution 123. The vertical hydroponic trough 173 may enclose the seedling roots 411 but give them the entire diameter of the trough to spread and grow. FIG. 4 shows that vertical hydroponic trough 173 is preferably a hollow structure that may allow for complete control of the plant root environment 402 and at the same time allow for room for the seedling roots 411 to spread and grow. With complete control of the plant root environment 402, which may include substantially preventing light from entering the closed loop system of the present disclosure, a user may reduce algae growth and provide for optimum growth of seedling 188. When the seedling 188 is of sufficient or desired size, the seedling 188 may be easily removed because the seedling roots 411 are not attached to any specific structure of the system.

In addition to holding the seedling 188 in place, the Stabilization collar 500 may seal around the seedling and maintain the nutrient aqueous solution 123 within the hydroponic vertical modular cultivation system.

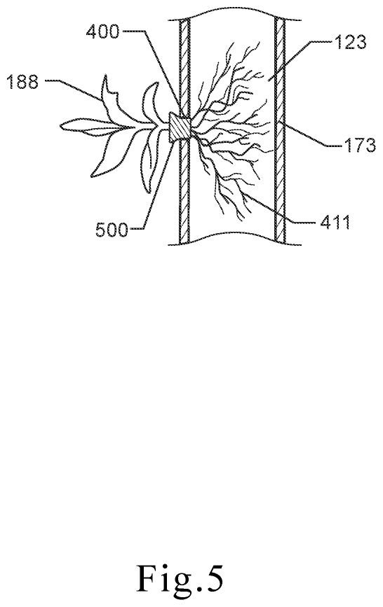

FIG. 5 is an illustration of a vertical cross-section view of the trough with a stabilization collar. FIG. 5 shows the hydroponic trough 173, which may be part of hydroponic vertical modular cultivation system panel 104 shown in FIG. 1. The nutrient aqueous solution 123 preferably fills the interior of the hydroponic trough 173 as it gradually flows in a cycle through the system. FIG. 5 shows that a stabilization collar 500 is matingly engaged with root access port 400, which may preferably be one of many holes in the sides of the hydroponic trough 173. Seedling 188 has been placed within stabilization collar 500. The leaves of seedling 188 are on the outside of hydroponic trough 173 and the seedling roots 411 are in the interior and are emersed within the nutrient aqueous solution 123. The vertical hydroponic trough 173 may enclose the seedling roots 411 but give them the entire diameter of the trough to spread and grow. FIG. 5 shows that vertical hydroponic trough 173 is preferably a hollow structure that may allow for complete control of the plant root environment 402 and at the same time allow room for the seedling roots 411 to spread and grow. When the seedling 188 is of sufficient or desired size, the seedling 188 may be easily removed because the seedling roots 411 are not attached to any specific structure of the system.

The seedling roots 411 may grow in any direction, horizontal, vertical, diagonal, etc., of the plant root environment 402. Because no growing media exists in the vertical hydroponic trough 173, other than the nutrient aqueous solution 123, the seedling 188 may be easily removed without damaging the seedling roots 411. Furthermore, because no growing media exist to obstruct the seedling roots 411, the roots may absorb the nutrients in the nutrient aqueous solution 123 to the maximum extent possible, and any unabsorbed nutrient aqueous solution 123 is drained and/or cycled away. This system allows for the seedling roots 411 to have a more efficient root respiration. In respiration, root cells burn glucose transported from the leaves. Glucose is transformed into cellular energy (adenosine triphosphate or ATP) that drives metabolic processes, mainly water and nutrient uptake. Without oxygen, respiration does not take place. Oxygen is the final electron acceptor in aerobic respiration, essential for transforming glucose into ATP. The total available oxygen to root cells matters for a healthy seedling 188 growth rate and crop yield. With a lot of oxygen available, root cells are essentially unlimited in the amount of sugar they can burn and how much water and nutrients may be absorbed. The plant root environment 402 of the present disclosure maximizes the seedling 188 respiration by allowing unobstructed absorption of the nutrient aqueous solution 123, which comprises a source of oxygen. Maximum seedling root 411 respiration leads to vigorous and more robust seedling 188.

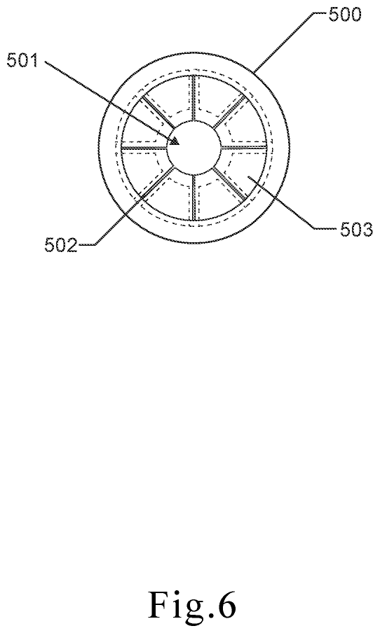

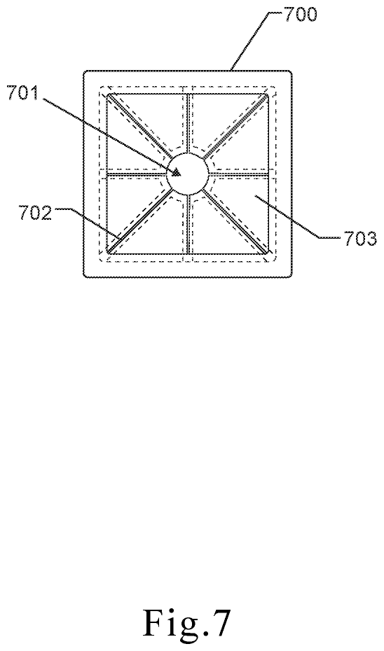

FIGS. 6 and 7 are illustrations of a front view of two embodiments of the stabilization collar. Although FIGS. 6 and 7 show two different shapes of the stabilization collar, stabilization collar 500 is cylindrical and stabilization collar 700 is rectangular or square, they may both have the same basic components, including, a unitary structure that may be made from neoprene, plastic, or the like, opening fins 503, 703, slits 502, 702, and a central opening 501, 701. Although the slits 502, 702 and central openings 501, 701 are shown of a certain size and width, this is exaggerated for purposes of clearly showing the parts of the stabilization collars 500, 700. The stabilization collars 500, 700 are configured to accept a seedling and hold it in place as it grows with the roots on an interior of central opening 501, 701 and with the leaves on an exterior of central opening 501, 701. The opening fins 503, 703 and the slits 502, 702 preferably compress and seal around the stem of the seedling, both holding the seedling in place and substantially preventing the nutrient aqueous solution from seeping out of the stabilization collar 500, 700. This allows the system to be completely and/or effectively closed, which substantially increases the efficiency of the entire system and substantially reduces waste and evaporation. The compression may be provided by the elasticity and flexibility of the materials from which the stabilization collars 500, 700 are made, such as neoprene, and/or may be provided by the configuration and shape of the opening fins 503, 703 and slits 502, 702. The compression may also be provided by an external device, such as an elastic band, that is attached to the stabilization collar 500, 700 after the seedling is put in place.

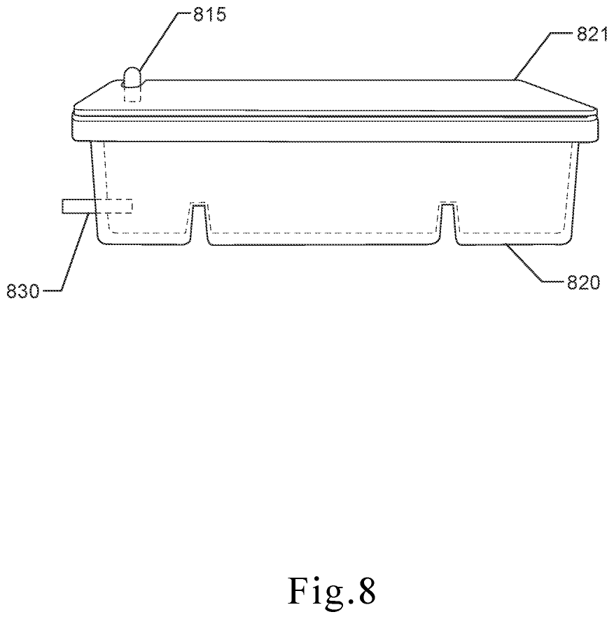

FIG. 8 is an illustration of one embodiment of covered nutrient supply reservoir. As shown in FIG. 8 the nutrient supply reservoir 820 may be engaged with or in close proximity to nutrient supply pipe 830 and nutrient return pipe 815. In this embodiment the nutrient supply reservoir 820 may have a reservoir cover 821 that may substantially prevent contamination and/or evaporation.

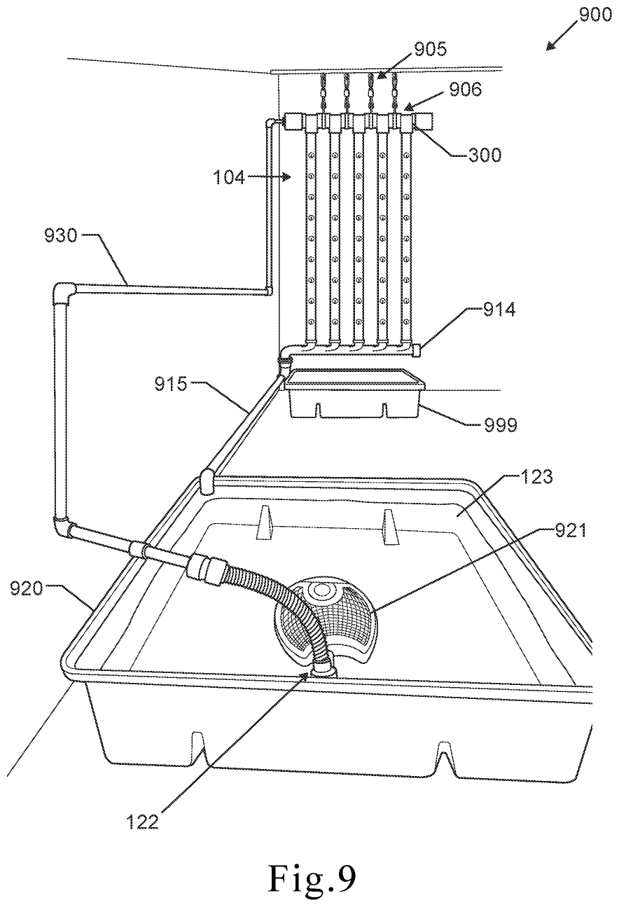

FIG. 9 is an illustration of a perspective view of one embodiment of a closed hydroponic vertical modular cultivation system. The closed hydroponic vertical modular cultivation system 900 may comprise a nutrient supply reservoir 920, a catch reservoir 999, a submersible system pump 921, a nutrient aqueous solution 123, a nutrient supply pipe 930, a drain return pipe 914, a nutrient return pipe 915, ceiling hangers 905, pipe hangers 906, nutrient distribution manifold 300, and hydroponic vertical modular cultivation system panel 104, which may be comprised of multiple vertical troughs.

The nutrient supply reservoir 920 and catch reservoir 999 may preferably be made from PVC or another plastic but can be any material suitable for holding the nutrient aqueous solution 123. Catch reservoir 999 may be used to collect any nutrient aqueous solution 123 that may leak from the closed hydroponic vertical modular cultivation system 900.

The submersible system pump 921 may be a submersible pump, as opposed to the system pump 221 shown in FIG. 2. A submersible pump may be submerged in the nutrient aqueous solution 123. The submersible system pump 921 may be placed inside the nutrient supply reservoir 920. Submersible system pump 921 may be any common type of pump used in hydroponic or liquid moving applications. A submersible pump tends to be cheaper, easier to use, faster to set up, and less noisy. In large systems, a submersible system pump may not have the power to drive the cyclical flow of the nutrient aqueous solution. In this case, an inline system pump may be the better option despite being louder and more expensive.

The systems, devices, and methods of the present disclosure may be configured to provide many distinct seedlings with their nutrients through the nutrient aqueous solution. The basic approaches to creating nutrient solutions are fertilizer programs, recipes, and complete fertilizers. Fertilizer programs consist of a complete fertilizer supplemented with macronutrients. To make a nutrient aqueous solution, a water solution may be supplemented with calcium nitrate and magnesium sulfate, depending on the variety and/or stage of plant growth. The advantages to fertilizer programs are they are easy to use, minimal ordering of fertilizers is needed, and making nutrient aqueous solutions requires very little or no mathematical calculations. Regarding the disadvantages of fertilizer programs, they do not allow for easy adjustments of individual nutrients. Another drawback is that fertilizer programs do not allow growers to account for nutrients in the water source. Recipes are also available to make nutrient solutions. Recipes contain an amount of each nutrient to add to the nutrient aqueous solution. They are typically specific to the type of plant being grown and are available from various sources, including university extension services, online, and trade magazines. Advantages of recipes include allowing for adjusting fertilizers based on nutrients in water sources. Recipes allow for quickly adjusting nutrients. Because recipes allow for easy adjustments, fertilizers can be used more efficiently than in fertilizer programs, and using recipes can be less costly than using fertilizer programs. Regarding the disadvantages of recipes, it is necessary to calculate how much fertilizer/nutrients to add to the nutrient aqueous solution. A high-precision scale may be required to measure micronutrients because of the small amounts needed. In the complete soluble fertilizer approach, nutrients are usually applied based on the plant's nitrogen needs. The advantage of using a complete fertilizer is that it is the simplest of the three approaches to making nutrient aqueous solutions. Only one fertilizer needs to be purchased. Disadvantages to using a complete fertilizer is that a complete fertilizer may not provide the proper balance of nutrients to plants. This approach may not provide adequate amounts of nutrients because they are simply not in the complete fertilizer.

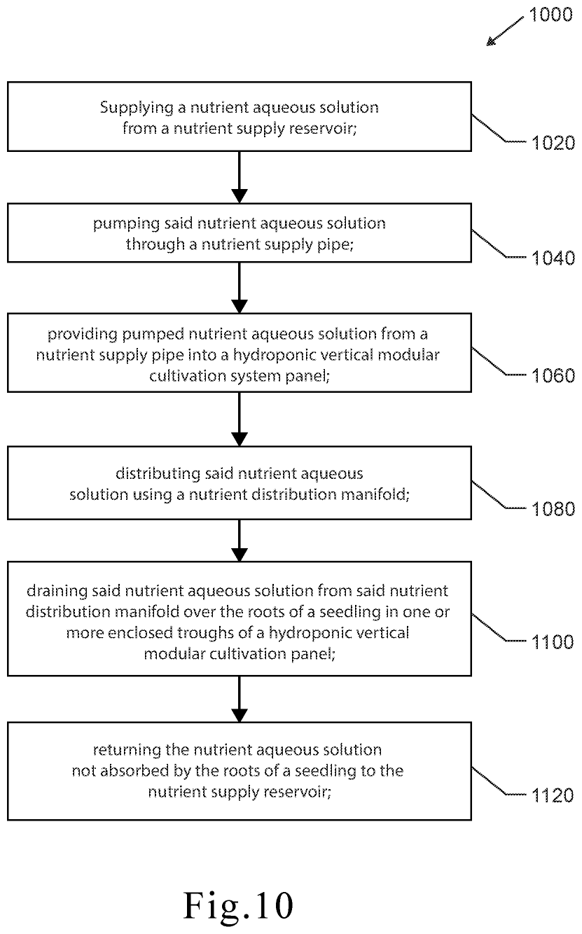

FIG. 10 a flow block diagram of a method of vertically cultivating seedlings a closed hydroponic vertical modular cultivation system.

The method 1000 may comprise the steps:
supplying a nutrient aqueous solution from a nutrient supply reservoir 1020
pumping the nutrient aqueous solution through a nutrient supply pipe 1040
providing pumped nutrient aqueous solution from a nutrient supply pipe into a hydroponic vertical modular cultivation system panel 1060
distributing the nutrient aqueous solution using a nutrient distribution manifold 1080
draining the nutrient aqueous solution from the nutrient distribution manifold over the roots of a seedling in one or more enclosed troughs of a hydroponic vertical modular cultivation panel 1100
returning the nutrient aqueous solution not absorbed by roots of a seedling to the nutrient supply reservoir 1120

The seedlings may each be held in a vertical stabilization collar, which are configured to matingly engage with the one or more enclosed troughs. The roots of the seedlings are allowed to expand within the hollow troughs and may be easily removed because the roots do not actually attach to any part of the system. The stabilization collars are preferably liquid tight and substantially prevent any of the nutrient aqueous solution from escaping to the exterior of the troughs.

Unless otherwise stated, all measurements, values, ratings, positions, magnitudes, sizes, locations, and other specifications that are set forth in this specification, including in the claims that follow, are approximate, not exact. They are intended to have a reasonable range that is consistent with the functions to which they relate and with what is customary in the art to which they pertain.

The foregoing description of the preferred embodiment has been presented for the purposes of illustration and description. While multiple embodiments are disclosed, still other embodiments will become apparent to those skilled in the art from the above detailed description. These embodiments are capable of modifications in various obvious aspects, all without departing from the spirit and scope of protection. Accordingly, the detailed description is to be regarded as illustrative in nature and not restrictive. Also, although not explicitly recited, one or more embodiments may be practiced in combination or conjunction with one another. Furthermore, the reference or non-reference to a particular embodiment shall not be interpreted to limit the scope of protection. It is intended that the scope of protection not be limited by this detailed description, but by the claims and the equivalents to the claims that are appended hereto.

Except as stated immediately above, nothing that has been stated or illustrated is intended or should be interpreted to cause a dedication of any component, step, feature, object, benefit, advantage, or equivalent, to the public, regardless of whether it is or is not recited in the claims.

What is claimed is:

1. A closed hydroponic vertical modular cultivation system, comprising:
one or more light sources;
at least one system pump;
at least one nutrient supply reservoir;
at least one nutrient supply pipe;
one or more hydroponic vertical modular cultivation system panels; and
at least one nutrient return pipe;
wherein each of said one or more light sources is vertically orientated and positioned approximately in front of at least one of said one or more hydroponic vertical modular cultivation system panels;
wherein said at least one system pump is configured to pump a nutrient aqueous solution contained within said at least one nutrient supply reservoir into said at least one nutrient supply pipe;
wherein said at least one nutrient supply pipe is configured to deliver said nutrient aqueous solution to said one or more hydroponic vertical modular cultivation system panels;
wherein each of said one or more hydroponic vertical modular cultivation system panels comprises:
a nutrient distribution manifold;
one or more vertical troughs, which are substantially hollow;
one or more stabilization collars; and
a drain return pipe;
wherein said nutrient distribution manifold comprises:
a manifold housing, which comprises one or more trough openings;
a nutrient supply pipe manifold portion, which comprises one or more openings;
wherein said one or more trough openings are configured to connect with said one or more vertical troughs;
wherein at least one of said one or more vertical troughs has one or more root access ports;
wherein said one or more root access ports are configured connect with said one or more stabilization collars;
wherein said one or more stabilization collars are configured to hold a seedling, such that a plurality of roots of said seedling are on an interior of said at least one of said one or more vertical troughs;
wherein said one or more stabilization collars are configured to be substantially free from leaking said nutrient aqueous solution;
wherein said at least one nutrient return pipe is configured to connect with said drain return pipe;
wherein said nutrient aqueous solution is cyclically pumped through said closed hydroponic vertical modular cultivation system; and
wherein said plurality of roots of said seedling absorbs said nutrient aqueous solution as said nutrient aqueous solution is cyclically pumped through said closed hydroponic vertical modular cultivation system.

2. The closed hydroponic vertical modular cultivation system of claim 1, further comprising:
a reservoir cover;
wherein said reservoir cover substantially covers a top of said nutrient supply reservoir.

3. The closed hydroponic vertical modular cultivation system of claim 1, wherein said one or more trough openings are configured to matingly seal with said one or more vertical troughs.

4. The closed hydroponic vertical modular cultivation system of claim 1, wherein said one or more openings of said nutrient supply pipe manifold portion are configured to be approximately located at said one or more trough openings; and
wherein said system pump is configured to variably control a flow rate of said nutrient aqueous solution through said closed hydroponic vertical modular cultivation system.

5. The closed hydroponic vertical modular cultivation system of claim 1, wherein said nutrient distribution manifold further comprises:
one or more end plugs; and
one or more adapters;
wherein said one or more end plugs substantially prevent said nutrient aqueous solution from leaving said nutrient distribution manifold except as through said one or more trough openings; and
wherein said one or more adapters are configured to allow said at least one nutrient supply pipe to pass into an interior of said nutrient distribution manifold.

6. The closed hydroponic vertical modular cultivation system of claim 1, wherein said one or more light sources comprises an array of light emitting diodes.

7. The closed hydroponic vertical modular cultivation system of claim 1, wherein said one or more light sources are configured to be an adjustable distance away from said one or more hydroponic vertical modular cultivation system panels.

8. The closed hydroponic vertical modular cultivation system of claim 1, wherein said system pump is configured to be submersible in said nutrient aqueous solution in said nutrient supply reservoir.

9. The closed hydroponic vertical modular cultivation system of claim 1, further comprising:
at least one catch reservoir;
wherein said at least one catch reservoir is configured to be placed underneath said one or more hydroponic vertical modular cultivation system panels and collect said nutrient aqueous solution that has escaped said closed hydroponic vertical modular cultivation system.

10. The hydroponic vertical modular cultivation system panel, of claim 1, further comprising:
one or more ceiling hangers; and
one or more pipe hangers;
wherein said one or more ceiling hangers and said one or more pipe hangers are configured to connect said one or more hydroponic vertical modular cultivation system panels to a ceiling, such that said one or more hydroponic vertical modular cultivation system panels hang from said ceiling in a substantially vertical manner.

11. The closed hydroponic vertical modular cultivation system of claim 1, wherein said one or more stabilization collars are neoprene.

12. A closed hydroponic vertical modular cultivation system, comprising:
a light source;
a system pump;
a nutrient supply reservoir;
a nutrient supply pipe;
a hydroponic vertical modular cultivation system panel; and
a nutrient return pipe;
wherein said system pump is configured to pump a nutrient aqueous solution contained within said nutrient supply reservoir into said nutrient supply pipe;
wherein said nutrient supply pipe is configured to deliver said nutrient aqueous solution to said hydroponic vertical modular cultivation system panel;
wherein said hydroponic vertical modular cultivation system panel comprises:
one or more vertical troughs, which are substantially hollow;
one or more stabilization collars;
wherein at least one of said one or more vertical troughs has one or more root access ports;
wherein said one or more root access ports are configured matingly seal with said one or more stabilization collars;
wherein each of said one or more stabilization collars are configured to hold a seedling, such that a plurality of roots of said seedling are on an interior of said at least one of said one or more vertical troughs;
wherein said nutrient aqueous solution is cyclically pumped through said closed hydroponic vertical modular cultivation system; and
wherein said plurality of roots of said seedling absorbs said nutrient aqueous solution as said nutrient aqueous solution is cyclically pumped through said closed hydroponic vertical modular cultivation system.

13. The closed hydroponic vertical modular cultivation system of claim 12, wherein said hydroponic vertical modular cultivation system panel further comprises:
a nutrient distribution manifold; and
a drain return pipe;
wherein said nutrient distribution manifold comprises:
a manifold housing, which comprises one or more trough openings; and
a nutrient supply pipe manifold portion, which comprises one or more openings;
wherein said one or more trough openings are configured to connect with said one or more vertical troughs; and
wherein said one or more stabilization collars are configured to be substantially free from leaking said nutrient aqueous solution; and
wherein said nutrient return pipe is configured to connect with said drain return pipe.

14. The closed hydroponic vertical modular cultivation system of claim 13, wherein said light source is vertically orientated and adjustably positioned in front of said hydroponic vertical modular cultivation system panel.

15. The closed hydroponic vertical modular cultivation system of claim 14, further comprising:
a reservoir cover;
wherein said reservoir cover substantially covers a top of said nutrient supply reservoir; and
wherein said system pump is configured to variably control a flow rate of said nutrient aqueous solution through said closed hydroponic vertical modular cultivation system.

16. The closed hydroponic vertical modular cultivation system of claim 15, wherein said one or more openings of said nutrient supply pipe manifold portion are configured to be approximately located at said one or more trough openings.

17. The closed hydroponic vertical modular cultivation system of claim 16, wherein said nutrient distribution manifold further comprises:
one or more end plugs; and
one or more adapters;
wherein said one or more end plugs substantially prevent said nutrient aqueous solution from leaving said nutrient distribution manifold except as through said one or more trough openings; and
wherein said one or more adapters are configured to allow said at least one nutrient supply pipe to pass into an interior of said nutrient distribution manifold.

18. The closed hydroponic vertical modular cultivation system of claim 17, further comprising:
a catch reservoir;
one or more ceiling hangers; and
one or more pipe hangers;
wherein said catch reservoir is configured to be placed underneath said hydroponic vertical modular cultivation system panel and to collect any of said nutrient aqueous solution that inadvertently escapes said hydroponic vertical modular cultivation system panel; and
wherein said one or more ceiling hangers and said one or more pipe hangers are configured to connect said one or more hydroponic vertical modular cultivation system panels to a ceiling, such that said one or more hydroponic vertical modular cultivation system panels hang from said ceiling in a substantially vertical manner.

19. A closed hydroponic vertical modular cultivation system, comprising:
a light source;
a system pump;
a nutrient supply reservoir;
a nutrient supply pipe;
a hydroponic vertical modular cultivation system panel;
a reservoir cover;
a catch reservoir;
one or more ceiling hangers;
one or more pipe hangers; and
a nutrient return pipe;
wherein said reservoir cover substantially covers a top of said nutrient supply reservoir;
wherein said light source is vertically orientated and adjustably positioned in front of said hydroponic vertical modular cultivation system panel;
wherein said system pump is configured to pump a nutrient aqueous solution contained within said nutrient supply reservoir into said nutrient supply pipe;
wherein said system pump is configured to variably control a flow rate of said nutrient aqueous solution through said closed hydroponic vertical modular cultivation system;
wherein said nutrient supply pipe is configured to deliver said nutrient aqueous solution to said hydroponic vertical modular cultivation system panel;
wherein said hydroponic vertical modular cultivation system panel comprises:
one or more vertical troughs, which are substantially hollow;
one or more stabilization collars;
wherein at least one of said one or more vertical troughs has one or more root access ports;
wherein said one or more root access ports are configured matingly seal with said one or more stabilization collars;
wherein each of said one or more stabilization collars are configured to hold a seedling, such that a plurality of roots of said seedling are on an interior of said at least one of said one or more vertical troughs;
wherein said nutrient aqueous solution is cyclically pumped through said closed hydroponic vertical modular cultivation system;
wherein said plurality of roots of said seedling absorbs said nutrient aqueous solution as said nutrient aqueous solution is cyclically pumped through said closed hydroponic vertical modular cultivation system;
wherein said catch reservoir is configured to be placed underneath said hydroponic vertical modular cultivation system panel and to collect any of said nutrient aqueous solution that inadvertently escapes said hydroponic vertical modular cultivation system panel; and
wherein said one or more ceiling hangers and said one or more pipe hangers are configured to connect said one or more hydroponic vertical modular cultivation system panels to a ceiling, such that said one or more hydroponic vertical modular cultivation system panels hang from said ceiling in a substantially vertical manner.

20. The closed hydroponic vertical modular cultivation system of claim 19, wherein said hydroponic vertical modular cultivation system panel further comprises:
a nutrient distribution manifold; and
a drain return pipe;
wherein said nutrient distribution manifold comprises:
a manifold housing, which comprises one or more trough openings; and
a nutrient supply pipe manifold portion, which comprises one or more openings;
one or more end plugs; and
one or more adapters;
wherein said one or more end plugs substantially prevent said nutrient aqueous solution from leaving said nutrient distribution manifold except as through said one or more trough openings;
wherein said one or more adapters are configured to allow said at least one nutrient supply pipe to pass into an interior of said nutrient distribution manifold;
wherein said one or more trough openings are configured to connect with said one or more vertical troughs;
wherein said one or more stabilization collars are configured to be substantially free from leaking said nutrient aqueous solution;
wherein said one or more openings of said nutrient supply pipe manifold portion are configured to be approximately located at said one or more trough openings; and
wherein said nutrient return pipe is configured to connect with said drain return pipe.
